(19) United States
(12) Patent Application Publication
(10) Pub. No.: US 2025/0361187 A1
(43) Pub. Date: Nov. 27, 2025

(54) CERAMIC CASTING METHOD AND FORMULATION

(71) Applicant: Dyson Technology Limited, Malmesbury, Wiltshire (GB)

(72) Inventors: Phoebe Louise TERELAK, Bristol (GB); Ying ZHU, Chippenham (GB)

(21) Appl. No.: 18/872,333

(22) PCT Filed: Jun. 8, 2023
(86) PCT No.: PCT/IB2023/055915

§ 371 Date: Dec. 6, 2024

(30) Foreign Application Priority Data
Jun. 16, 2022 (GB) 2208837.1

(51) Int. Cl. C04B 35/581; C04B 35/634; C04B 41/45

(52) U.S. Cl. CPC C04B 35/581; C04B 35/63464; C04B 41/4578; C04B 2235/6027

(57) ABSTRACT

A method of casting an aluminium nitride ceramic component involving providing an aluminium nitride ceramic slurry, the slurry containing: aluminium nitride powder; a solvent; and a polymer binder, wherein the slurry contains no more than 5 wt % polymer binder; slip casting a green product using the slurry; and sintering the green product to dry to produce the aluminium nitride ceramic component.

### TECHNICAL FIELD

The present invention relates to a method of casting an aluminium nitride ceramic component, such as a heater component.

### BACKGROUND

Aluminium nitride ceramic components, such as those used in ceramic heaters, are typically manufactured by casting components from ceramic pre-cursors, for example aluminium nitride ceramic slurries. An aluminium nitride ceramic slurry comprises aluminium nitride ceramic particles suspended in a liquid. The slurry also typically includes a binder. Such a slurry is described for example in U.S. Pat. No. 9,340,462, which comprises aluminium nitride with yttria additives, and a binder. A tape casting slurry based on yttrium aluminium garnet (YAG) is also described in U.S. Pat. No. 7,799,267.

The slurry is used to cast a ‘green’ component, which is then sintered to form the final product. The sintering process typically burns off any liquid, and the binder, and fuses and densifies the ceramic particles together, leaving only the densified ceramic forming the final product.

To manufacture aluminium nitride ceramic components for ceramic heaters, it is typical to use a tape-casting method. The ceramic slurry is applied to a tape or ribbon in a continuous process to produce a green product. The tape with the ceramic slurry is sintered to provide the final product. To integrate the ceramic components into a heater, the tapes are layered up, with electronic hardware is laminated onto the sintered ceramic between the layers.

Such tape casting processes are efficient and produce high-quality ceramic products. However, there are limitations on shapes that can be produced. It is also challenging to incorporate the electronic hardware, and the multi-layer structure provides locations for defects between the layers.

It is against this background that the invention has been devised.

### SUMMARY OF THE INVENTION

In accordance with a first aspect of the present invention, there is provided a method of casting an aluminium nitride ceramic component. The method comprises providing an aluminium nitride ceramic slurry, the slurry comprising: aluminium nitride powder; a solvent; and a polymer binder, wherein the slurry comprises no more than 5 wt % polymer binder; slip casting a green product using the slurry; and sintering the green product to dry to produce the aluminium nitride ceramic component.

The slurry may comprise no more than 2.5 wt % polymer binder, and optionally comprises between 0.1 wt % and 1.5 wt % polymer binder.

The polymer binder may comprise polypropylene carbonate.

The solvent may comprise DMP, DMC, MEK or NUP. The slurry may comprise between 30 wt % and 40 wt % solvent.

The aluminium nitride powder may comprise aluminium nitride particles having a median particle size that is between 1 micron and 10 microns in diameter.

The slurry may further comprise a dispersant. The dispersant may comprise an isobutyl methacrylate polymer and/or a phosphate ester. The slurry may comprise approximately 0.5 wt % to approximately 1.5 wt % dispersant.

The slurry may comprise one or more additional ceramic additives. The slurry may comprise up to approximately 10 wt % additional ceramic additive, and preferably comprises up to approximately 5 wt % additional ceramic additive. The additional ceramic additive comprises a ceramic material other than aluminium nitride, and may comprise for example alumina and/or yttria.

The method may further comprise providing a slip-casting mould having a mould surface, slip casting the slurry on the mould surface and allowing the slurry to dry to produce the green product.

The method may comprise applying a lubricant to the mould surface before slip casting the slurry onto the mould surface.

The method may comprise arranging electronic components on the mould surface and slip casting the slurry on the mould surface over the electronic components so that the electronic components are embedded in the green product.

The mould surface may be substantial free of macroscopic pores.

The method may comprise using the green product as a further slip casting mould to slip cast a further layer of ceramic slurry on the green product, thereby producing a laminated green product.

In this case, a first ceramic slurry may be used to form the green product, and a second ceramic slurry may be used to form the further layer of ceramic slurry. The first ceramic slurry may be different to the second ceramic slurry. The first and second ceramic slurries may for example comprise different ceramic additives.

The method may comprise sintering the green product to produce the aluminium nitride ceramic component.

The aluminium nitride ceramic component may be a heater component.

The invention also extends to an aluminium nitride ceramic slurry for use in slip casting an aluminium nitride ceramic component, the slurry comprising an aluminium nitride powder; a solvent; and a polymer binder; wherein the slurry comprises no more than 5 wt % polymer binder. The slurry may have the preferred and/or optional features described above.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIGS. 1 and 2 are scanning electron microscope (SEM) micrograph of a sample ceramic components made according to the invention.

General and specific embodiments of the invention will be described below with reference to the Figures.

### DESCRIPTION OF EMBODIMENTS OF THE INVENTION

An aluminium nitride ceramic component, such as a ceramic heater component, can be manufactured using a slip-casting process. Such a component is made using an aluminium nitride ceramic slurry that is specially formulated.

The aluminium nitride ceramic slurry comprises an aluminium nitride powder, a polymer binder, and a liquid component that comprises a solvent. The proportion of polymer binder in the slurry is no greater than 5 wt %, preferably no greater than 2.5 wt %, and is optionally between approximately 0.1 wt % and 1.5 wt %.

The slurry may also comprise further ceramic additives (i.e. ceramic components other than aluminium nitride). The liquid component may comprise a solvent mixture (i.e. a mixture of more than one solvent), and may comprise dispersants and/or plasticisers in addition to the solvent(s).

The slurry components, method of making the slurry, and methods of slip casting will now be described in more detail.

### Slurry Components

Aluminium nitride powder: The aluminium nitride powder comprises particles of aluminium nitride that may be of any suitable size distribution and shape distribution. A suitable powder may for example comprise substantially spherical particles having a median size of 1 to 10 microns. However, other shapes and sizes may be used, and may for example be selected according to the application. The slurry preferably comprises approximately 50 wt % to approximately 65 wt % aluminium nitride powder.

Solvent: The solvent preferably comprises a solvent mixture, which may comprises for example one or more of DMC, DMP, MEK and NMP. The slurry preferably comprises approximately 30 wt % to approximately 40 wt % solvent.

Polymer Binder: The polymer binder may be any suitable polymer material that is capable of binding the ceramic slurry. An example of a suitable polymer binder is polypropylene carbonate, for example in the form of the product commercially available as QPAC® 40. The proportion of polymer binder in the slurry is no greater than 5 wt %, preferably no greater than 2.5 wt %, and is optionally between approximately 0.1 wt % and 1.5 wt %. A particularly preferred proportion is approximately 0.3 to 0.5 wt %.

Dispersants: optionally the slurry may include dispersant. Examples of suitable dispersants are an isobutyl methacrylate polymer (for example Acryloid B67) and a phosphate ester (for example Rhodafac RE610). Where dispersants are included the slurry may comprise approximately 0.5 wt % to approximately 1.5 wt % dispersants. The slurry may contain a dispersant mixture: for example, a mixture of Acryloid B67 and Rhodafac RE610

Ceramic additives: optionally the slurry may include ceramic additives. Examples of suitable additives are yttria (Y203) and alumina (Al2O3). Where ceramic additives are included the slurry may comprise up to approximately 10 wt % additional ceramic additives. The ceramic additive powders may comprise particles that may be of any suitable size distribution and shape distribution.

Plasticiser: optionally the slurry may include a plasticiser. The plasticiser may optionally also act as a solvent. The plasticiser may be a monomer form of the polymer binder. An example of a suitable plasticiser is propylene carbonate, which may in particular be used as a plasticiser when the polymer binder is a polypropylene carbonate. Where a plasticiser is included the slurry may comprise up to approximately 2 wt % plasticiser.

### Methods of Making the Slurry

The Slurry is made in a multi-stage milling process, of the sort described for example in U.S. Pat. No. 7,799,267.

In a first milling stage, any ceramic additives are combined with any dispersants and with a first solvent or first solvent mixture. The mixture is then subject to milling on a roller with a milling media, for example a zirconia milling media. The milling period may be any suitable period, but is preferably at least 4 hours.

In a second milling stage, the mixture produced from the first milling stage is combined with a second solvent or solvent mixture, the aluminium nitride ceramic, and the plasticiser. The mixture is then subject to milling on a roller with a milling media, for example a zirconia milling media. The milling period may be any suitable period, but is preferably at least 4 hours.

In a final milling stage, the mixture produced from the second milling stage is combined with the binder and a third solvent or solvent mixture. The mixture is then subject to milling on a roller with a milling media, for example a zirconia milling media. The milling period may be any suitable period, but is preferably at least 4 hours. After the final milling stage, the slurry can be used for slip casting.

### Methods of Slip Casting

The slip casting process is carried out using a suitable slip casting mould. The mould may be made from any suitable material, for example gypsum plaster (plaster of paris). The mould comprises a mould surface against which the slurry is moulded. The moulded surface is smooth, and in particular is free of macroscopic pores i.e. there are no pores having a diameter greater than 50 microns, and preferably no pores having a diameter greater than 10 microns.

A lubricant is preferably applied to the mould surface. A particularly suitable lubricant is WD40, though other lubricants may be used such as PTFE and petroleum jelly.

The component is then made by slip casting the slurry onto the slip casting mould. To this end, a quantity of the slurry is poured into the mould cavity and into contact with the mould surface. The slurry is then poured out of the cavity, and due in particular to the binder that is present in the slurry, a layer of the slurry material remains behind on the mould surface. The slurry is left for a short period of time, during which the solvents are drawn into the pores of the mould. As the solvent is removed in this way, the slurry dries into a green body, which shrinks slightly away from the mould surface. The shrinkage allows the green body to be demoulded. Demoulding is further facilitated by the lubricant, and is in particularly facilitated by the relatively low amount of binder in the slurry. The low proportion of binder results in a relatively low strength of the green body, but surprisingly it has been found that the low binder amount allows the green body sufficient strength to be demoulded.

After demoulding the green body is sintered according to known sintering methods to form the finished product.

The slip casting method produces a ceramic component with good structural integrity that retains the shape of the green product. The slip casting process allows production of components having more complex shapes than conventional ribbon casting techniques, such as tubes, cones or other shapes with bends, edges and curved surfaces.

In some embodiments, different ceramic slurries having different ceramic components may be used. For example, a first ceramic slurry may be used with a first ceramic additive, and a second ceramic slurry may be used with a second ceramic additive that is different to the first ceramic additive.

The different ceramic slurries may be used to slip case different regions of the same component, providing different regions with different properties. Alternatively, the different ceramic slurries may be layered. For example, a green product may be made using a first ceramic slurry, and the green product may then be used as a mould defining a mould surface to slip cast a second ceramic slurry, thereby providing a layered structure wherein the layers have different properties.

The method described may also be used to form ceramic components with integrated electronical components such as wires, circuit components, thermocouples and other electronically functional parts. In this case, the electrical components may first be arranged so that the supported on or above the mould surface of the mould, and the slurry may then be poured onto the mould surface around the electrical components. To this end, the electrical components may be arranged directly on the mould surface, or the electrical components may be jigged or otherwise suspended above the mould surface. The slurry is then poured out of the mould leaving a layer of slurry over the mould surface and electrical components. As the slurry dries and the green product is formed, the electrical components are embedded in the green product.

### EXAMPLES

### Samples 1 and 2

Two ceramic components were made using two slurry mixtures according to Sample 1 and Sample 2 set out in the table below.

| Stage | Component | Wt % Sample 1 | Wt % Sample 2 |
|---|---|---|---|
| 1st Milling | Acryloid B67 | 0.2 | 0.2 |
| stage | Rhodafac RE 610 | 0.6 | 0.6 |
| ingredients | Dimethyl carbonate | 27.7 | 28.4 |
| | Yttria | 3 | 3 |
| | Alumina | 0.3 | 0.3 |
| 2nd Milling | Dimethyl phthalate | 0.9 | 0.9 |
| stage | Propylene carbonate | 0.9 | 0.9 |
| ingredients | Dimethyl carbonate | 3.3 | 3.3 |
| | Aluminium Nitride | 57 | 58.6 |
| Final stage | Polypropylene carbonate | 2.1 | 0.4 |
| ingredients | Methyl ethyl ketone | 4 | 0.8 |

To make the samples, the first milling stage components were mixed and milled on a roller using a zirconia milling media for a milling time of four hours. The second milling stage ingredients were added and the mixture was again milled on a roller using a zirconia milling media for a milling time of four hours. The final stage ingredients were added and the mixture was rolled so that all parts were combined.

Slip casting moulds were made by moulding gypsum plaster around silicon RTV moulds of desired shapes, including cuboids, hemispheres, cones and plates. WD40 was applied to the mould surface, and electronic components were arranged on the mould surface.

Green products were made by slip casting the slurry mixtures of the two samples in a respective mould, pouring the slurry away to leave a coating on the mould surface and electronic components, and allowing the slurry to dry.

The green products with embedded electronic components could be removed from the moulds after drying.

The green products were then sintered at appropriate temperatures between 170° and 1850° C. The sintered components retained their shape from the green product, and retained their structural integrity, with the electronic components embedded in the product.

### Samples 3 and 4

Two samples were made using a slurry having the ingredients of Sample 2 above, with aluminium nitride powder comprising particles of different size distributions.

### Sample 3

Median particle size: 1.2 microns
D10 particle size: 0.7 microns
D90 particle size: 3.2 microns

### Sample 4

Median particle size: 9.4 microns
D10 particle size 1.9 microns
D90 particle size: 34 microns

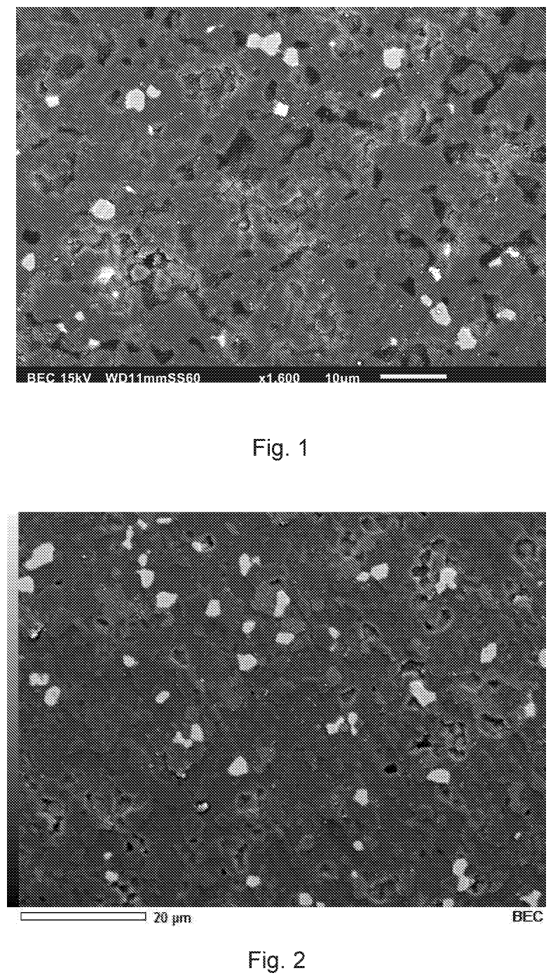

FIGS. 1 and 2 are SEM micrographs of Samples 3 and 4, and show a solid ceramic with low level porosity and good integrity.

1. A method of casting an aluminium nitride ceramic component, the method comprising:
providing an aluminium nitride ceramic slurry, the slurry comprising:
aluminium nitride powder;
a solvent; and
a polymer binder;
wherein the slurry comprises no more than 5 wt % polymer binder;
slip casting a green product using the slurry; and
sintering the green product to dry to produce the aluminium nitride ceramic component.

2. The method of claim 1, wherein the slurry comprises no more than 2.5 wt % polymer binder, and preferably between 0.1 wt % and 1.5 wt % polymer binder.

3. The method of claim 1, wherein the polymer binder comprises polypropylene carbonate.

4. The method of claim 1, wherein the solvent comprises DMP, DMC, MEK or NMP.

5. The method of claim 1, wherein the slurry comprises between 30 wt % and 40 wt % solvent.

6. The method of claim 1, wherein the slurry further comprises a dispersant.

7. The method of claim 6, wherein the dispersant comprises an isobutyl methacrylate polymer and/or a phosphate ester.

8. The method of claim 6, wherein the slurry comprises approximately 0.5 wt % to approximately 1.5 wt % dispersant.

9. The method of claim 1, wherein the slurry comprises one or more additional ceramic additives.

10. The method of claim 9, wherein the slurry comprises up to approximately 10 wt % additional ceramic additive.

11. The method of claim 1 further comprising:
providing a slip-casting mould having a mould surface;
slip casting the slurry on the mould surface and allowing the slurry to dry to produce the green product.

12. The method of claim 11 comprising applying a lubricant to the mould surface before slip casting the slurry onto the mould surface.

13. The method of claim 11, comprising:
arranging electronic components on the mould surface; and
slip casting the slurry on the mould surface over the electronic components so that the electronic components are embedded in the green product.

14. The method of claim 1, comprising using the green product as a further slip casting mould to slip cast a further layer of ceramic slurry on the green product, thereby producing a laminated green product.

15. The method of claim 14, wherein a first ceramic slurry is used to form the green product, and a second ceramic slurry is used to form the further layer of ceramic slurry, the first ceramic slurry being different to the second ceramic slurry.

16. The method of claim 1, comprising sintering the green product to produce the aluminium nitride ceramic component.

17. The method of claim 1, wherein the aluminium nitride ceramic component is a heater component.

18. An aluminium nitride ceramic slurry for use in slip casting an aluminium nitride ceramic component, the slurry comprising:
aluminium nitride powder;
a solvent; and
a polymer binder
wherein the slurry comprises no more than 5 wt % polymer binder.
